(19) United States
(12) Patent Application Publication
(10) Pub. No.: US 2026/0111323 A1
(43) Pub. Date: Apr. 23, 2026

(54) DYNAMIC ALLOCATION OF TESTING EQUIPMENT

(71) Applicant: Toyota Jidosha Kabushiki Kaisha, Toyota-shi Aichi-ken (JP)

(72) Inventors: Vijay Kumar Adusumilli, McKinney, TX (US); Joshua Scott Smith, Livonia, MI (US); Vinodkumar Mudaliar, Chandler, AZ (US); Sean S. Norris, Washington, DC (US)

(73) Assignee: Toyota Jidosha Kabushiki Kaisha, Toyota-shi Aichi-ken (JP)

(21) Appl. No.: 19/428,654

(22) Filed: Dec. 22, 2025

Related U.S. Application Data
(63) Continuation-in-part of application No. 18/771,089, filed on Jul. 12, 2024.

(51) Int. Cl. G06F 11/273

(52) U.S. Cl. CPC G06F 11/273

(57) ABSTRACT

Embodiments described herein relate to dynamic allocation of testing equipment. In one implementation, a method includes receiving a request to perform a test using at least one test device. The method also includes determining testing characteristics associated with the request. The method also includes creating, using an allocation model based, at least in part, on the testing characteristics, an allocation of a remote device from a testing pool to operate as the at least one test device for executing the test. The method further includes providing the allocation to reserve the remote device and schedule a test session.

### CROSS-REFERENCE TO RELATED APPLICATIONS

This application is a continuation-in-part of prior U.S. Application No. 18/771,089, filed on July 12, 2024.

### TECHNICAL FIELD

The subject matter described herein relates, in general, to reserving testing resources and, more particularly, to allocating testing equipment to facilitate scheduling of test sessions and reservation of testing equipment.

### BACKGROUND

In the development and validation of vehicle systems, specialized testing equipment is typically needed for evaluating the performance and reliability of various components and subsystems. Traditionally, such equipment is configured for specific testing scenarios, making it difficult to adapt to changing testing requirements or to share resources efficiently across different projects of varying deadlines and criticality. As the complexity and volume of vehicle testing increases, organizations face significant challenges in managing, maintaining, and allocating testing resources.

For example, accurately forecasting the demand for testing equipment may be difficult, which can result in either shortages that delay critical testing activities or excess capacity that leads to unnecessary costs. Furthermore, there are challenges associated with systematically monitoring how testing equipment is utilized, making it difficult to identify which resources are most frequently needed. Accordingly, existing approaches lead to inefficient use of resources, difficulties in scheduling, and challenges in budgeting for testing activities.

### SUMMARY

The embodiments described herein are directed to a testing system for allocating testing equipment. As noted above, existing systems for managing testing equipment may lack dynamic allocation and cost optimization, leading to inefficient use of resources, difficulties in scheduling, and challenges in budgeting for testing activities. Accordingly, in one approach, a testing system receives a request to perform a test using a test device from a pool of devices. The devices, in one embodiment, are remote devices such as vehicle electronic control units (ECUs) for executing vehicle tests. In one embodiment, the testing system determines testing characteristics associated with the request, such as criticality, timing, and device requirements. Using an allocation model based, at least in part, on the testing characteristics and historical usage, the testing system, in one approach, allocates at least one of the remote devices to operate as the test device and provides the allocation to reserve the remote device and schedule a test session. In further arrangements, the testing system aggregates information about historical allocations and usage to identify variances between planned reservations and actual use. Based on the aggregated data, the testing system, in one embodiment, adjusts future allocations by setting appropriate reservation lengths, moving low-criticality requests into available windows, and ensuring compatibility between requests and assigned devices. The testing system can also dynamically optimize capacity by initiating additional test devices or reconfiguring existing test benches to add needed devices or repurpose underused devices, thereby improving utilization, minimizing waiting times, and aligning reservations with project and budget constraints.

In one embodiment, a testing system is disclosed. The testing system includes a processor and a memory communicably coupled to the processor. The memory stores an allocation module including instructions that, when executed by the processor, cause the processor to receive a request to perform a test using at least one test device. The instructions also cause the processor to determine testing characteristics associated with the request. The instructions also cause the processor to create, using an allocation model based, at least in part, on the testing characteristics, an allocation of a remote device from a testing pool to operate as the at least one test device for executing the test. The instructions further cause the processor to provide the allocation to reserve the remote device and schedule a test session.

In another embodiment, a non-transitory computer-readable medium is disclosed. The non-transitory computer-readable medium includes instructions that, when executed by a processor, cause the processor to receive a request to perform a test using at least one test device. The instructions also cause the processor to determine testing characteristics associated with the request. The instructions also cause the processor to create, using an allocation model based, at least in part, on the testing characteristics, an allocation of a remote device from a testing pool to operate as the at least one test device for executing the test. The instructions further cause the processor to provide the allocation to reserve the remote device and schedule a test session.

In yet another embodiment, a method is disclosed. The method includes receiving a request to perform a test using at least one test device. The method also includes determining testing characteristics associated with the request. The method also includes creating, using an allocation model based, at least in part, on the testing characteristics, an allocation of a remote device from a testing pool to operate as the at least one test device for executing the test. The method further includes providing the allocation to reserve the remote device and schedule a test session.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one example of a testing system that is associated with allocating test devices for testing.

FIG. 2 illustrates one example of the system of FIG. 1 in a cloud-computing environment.

FIG. 3 illustrates one example of a testing pool of remote test devices.

FIG. 4 illustrates one example of a method for allocating a test device from the testing pool.

FIG. 5 illustrates one example of a method for allocating a test device according to historical allocations and use of a testing pool.

### DETAILED DESCRIPTION

The embodiments described herein are directed to a testing system for allocating testing equipment. As noted above, existing systems for managing testing equipment may lack dynamic allocation and cost optimization, leading to inefficient use of resources, difficulties in scheduling, and challenges in budgeting for testing activities. Accordingly, in one approach, a testing system receives a request to perform a test using a test device from a pool of devices. The devices, in one embodiment, are remote devices such as vehicle electronic control units (ECUs) for executing vehicle tests. In one embodiment, the testing system determines testing characteristics associated with the request, such as criticality, timing, and device requirements. Using an allocation model based, at least in part, on the testing characteristics and historical usage, the testing system, in one approach, allocates at least one of the remote devices to operate as the test device and provides the allocation to reserve the remote device and schedule a test session. In further arrangements, the testing system aggregates information about historical allocations and usage to identify variances between planned reservations and actual use. Based on the aggregated data, the testing system, in one embodiment, adjusts future allocations by setting appropriate reservation lengths, moving low-criticality requests into available windows, and ensuring compatibility between requests and assigned devices. The testing system can also dynamically optimize capacity by initiating additional test devices or reconfiguring existing test benches to add needed devices or repurpose underused devices, thereby improving utilization, minimizing waiting times, and aligning reservations with project and budget constraints.

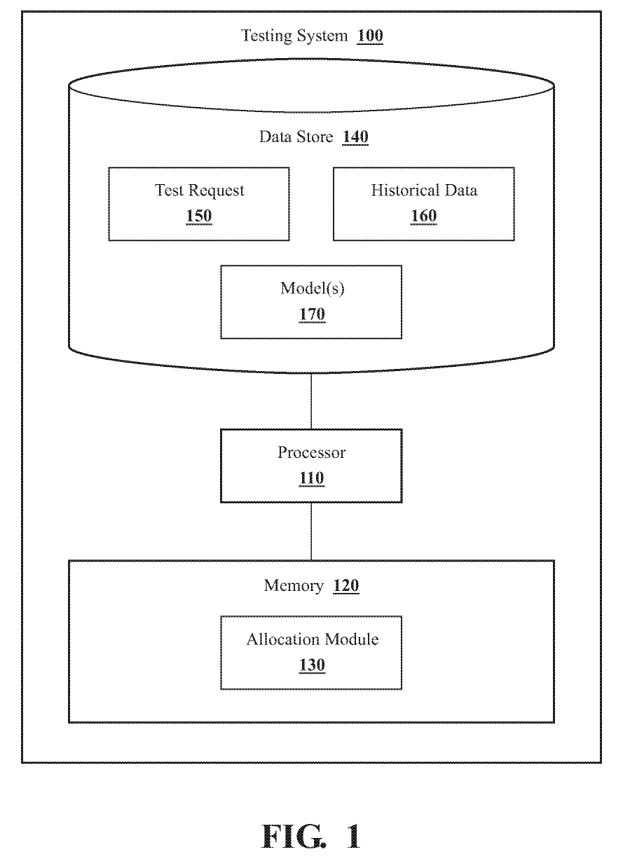

With reference now to FIG. 1, one embodiment of the testing system 100 is illustrated. The testing system 100 is shown as including a processor 110. The processor 110 may be a part of the testing system 100, the testing system 100 may include a separate processor, or the testing system 100 may access the processor 110 through a data bus or another communication path. In one embodiment, the testing system 100 includes a memory 120 that stores an allocation module 130. The memory 120 is a random-access memory (RAM), read-only memory (ROM), a hard-disk drive, a flash memory, or other suitable memory for storing the allocation module 130. The allocation module 130 includes, for example, computer-readable instructions that when executed by the processor 110 cause the processor 110 to perform the various functions disclosed herein. In alternative arrangements, the allocation module 130 includes independent elements from the memory 120 that are, for example, comprised of hardware elements. Thus, the allocation module 130 alternatively includes ASICs, hardware-based controllers, a composition of logic gates, or another hardware-based solution.

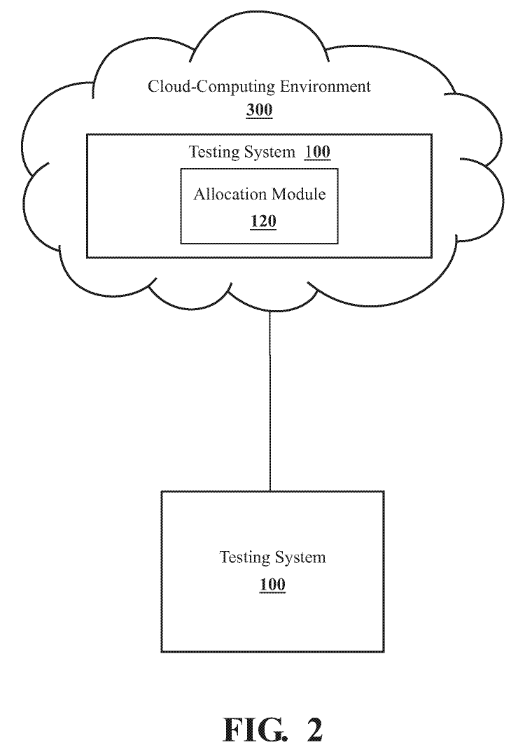

The testing system 100, as illustrated in FIG. 1, is generally an abstracted form of the testing system 100 as may be implemented between a device and a cloud-computing environment. FIG. 2 illustrates one example of a cloud-computing environment 200 that may be implemented along with the testing system 100. As illustrated in FIG. 2, the testing system 100 is embodied at least in part within the cloud-computing environment 200.

Accordingly, as shown, the testing system 100 may include separate instances within one or more entities of the cloud-based environment 200, such as servers, and also instances within one or more remote entities (e.g., computing devices) that function to acquire, analyze, and distribute the noted information. In a further aspect, the set of entities that function in coordination with the cloud environment 200 may be varied.

In one embodiment, the cloud-computing environment 200 includes services that run in a cloud environment, which may be public or private, and which coordinate allocations and reservations, expose request and scheduling interfaces, and enforce access policies. Moreover, in one embodiment, the remote entity is the remote infrastructure including computing devices accessed by the requesting party that execute the allocations issued by the cloud-computing environment 200. The remote entity reports availability and status, applies reservations, and manages local session control. Communications between the cloud-computing environment 200 and the remote entity occur, in one implementation, over secure network links. In some arrangements, the cloud-computing environment 200 and the remote entity serve logically distinct roles even if employed in the same data center.

With continued reference to FIG. 1, in one embodiment, the testing system 100 includes a data store 140. The data store 140 is, in one embodiment, an electronic data structure stored in the memory 120 or another data store and that is configured with routines that can be executed by the processor 110 for analyzing stored data, providing stored data, organizing stored data, and so on. Thus, in one embodiment, the data store 140 stores data used by the allocation module 130 in executing various functions. In one embodiment, the data store 140 stores a test request 150, historical data 160, and model(s) 170, each of which will be described in turn in further detail below.

Regarding the test request 150, in one embodiment, the test request 150 is a submission provided through a user interface or a programmatic interface, for example, which specifies various testing characteristics for executing the test. The testing system 100, in one approach, receives the submission and stores the submission as the test request 150 in the data store 140. The test request 150 can originate from engineers manipulating an electronic interface, automated pipelines, or project management systems and may arrive in multiple forms. Examples of forms for the test request 150 include a web-form submission via a graphical user interface (GUI) of the testing system 100; an application programming interface (API) call (e.g., REST/JSON) from a continuous integration/continuous deployment (CI/CD) pipeline, a feature testing workflow, or a debugging tool; a machine-readable message placed on a message queue or service bus used by orchestration systems; and/or a scheduled reservation file (e.g., JSON, YAML, CSV) uploaded through a portal or synchronized from a calendar or scheduling system.

As mentioned above, the test request 150 includes various testing characteristics that outline various parameters for executing the test. The testing characteristics include, in one implementation, request-side testing characteristics and server-side testing characteristics. The request-side testing characteristics relate to the requested test, a requested device, and/or a requesting party, while the server-side testing characteristics relate to the remote devices in the testing pool.

Regarding the request-side testing characteristics, in one arrangement, the request-side testing characteristics include an identity or identifying information regarding the requesting user, party, and/or team (herein referred to as the user); a project code; engineering hours required for the test; cost and/or budget parameters relating to the requested test or user; authorization to access specific test devices by the user, a specific test device requested by the user; timing of the test (requested start time, latest acceptable finish time, expected duration of execution, a criticality of the test (e.g., low criticality or high criticality), deadlines related to the test, whether the timing is fixed or flexible, etc.); a type of planned usage for the test device (e.g., whether the test is a smoke test, an integration test, etc.); a type of on-demand usage for the test device (e.g., CI/CD, feature testing in development, debugging, etc.); costs associated with engineering time to execute the test; and/or costs associated with delays due to unavailability of test devices. The request-side characteristics can also include preferences set by a management group of the user, for example, related to a specific budget or project.

Regarding planned and on-demand usage, as mentioned above, in some cases, the user has a known or planned usage associated with tests for different projects (e.g., as a new vehicle is developed), which may further define explicit testing characteristics. In addition to or alternatively to the planned usage, the user may have an on-demand usage associated with various projects that does not occur on a specific planned timeline but may have a cyclic nature associated with common deadlines (e.g., end of quarter). Accordingly, testing characteristics can include these parameters.

Turning now to the server-side testing characteristics, in one implementation, the server-side testing characteristics include information regarding the remote devices in the testing pool. For example, the server-side testing characteristics include a number of remote devices in the testing pool; an availability and/or a suitability of the remote devices to satisfy the request and operate as the test device for executing the test; whether the remote devices are online or inaccessible; a cost of use of the remote devices; a cost of a testing bench formed form a subset of the remote devices; and/or an availability of a remote devices that matches the request-side characteristics, etc.

Regarding the historical data 160, in one embodiment, the historical data 160 includes records describing prior test requests, prior allocations, and prior usage of the remote devices from the testing pool. The historical data 160, in one implementation, includes timestamps and durations of test sessions; device availability and utilization; identities of allocated remote devices; characteristics of past requests (e.g., project context, device-under-test details, required bench configurations, timing windows, criticality, resource counts); observed wait times versus requested schedules; and outcomes such as completion status and any deviations from planned execution. In one arrangement, the historical data 160 further captures variances between predicted allocations and actual usage, including instances of under-allocation or over-allocation and the associated costs or delays. In one embodiment, the testing system 100 retains the historical data 160 for a rolling horizon sufficient to capture seasonal and program-cycle effects, such as at least the prior 12 months of requests, allocations, and usage. In other embodiments, the retention window is configurable by management (e.g., 6–24 months or longer) to balance model accuracy and data storage cost, with older data archived for offline analysis while the active window is used for real-time allocation and forecasting. In any case, as described in further detail below, the testing system 100 leverages the historical data 160 to identify patterns in demand and usage to further improve dynamic allocation of testing devices.

In one embodiment, the testing system 100 models each request and each remote device as a collection of tags expressed as key: value pairs (e.g., device_type:ECU-G2, bench:VHI-4, usage: CI, project: ALPHA, criticality: high, deadline: 2025-01-15). The allocation module 130, in one approach, maintains a time-indexed tag store that records historical reservations and actual usage across individual tags and tag combinations, enabling fast aggregation (e.g., per-tag demand curves, co-occurrence matrices, and utilization histograms). A reservation priority queue can use these tag features to compute a dynamic priority score for queued requests as a function of tag weights, SLA/criticality, deadline aging, setup/reconfiguration cost for matching tag constraints, and learned congestion levels derived from the historical data 160 for the same tags and time-of-day/week/quarter. The queue supports preemption and backfilling by comparing tag-compatible candidates and can advance lower-criticality requests into transient capacity gaps discovered by short-horizon forecasts conditioned on tag distributions. Storing reservations with their tag sets also enables post hoc drift detection between planned and actual usage at the tag level, which the model(s) 170 can leverage to recalibrate future tag weights, reservation lengths, and bench compositions.

Turning now to the model(s) 170, in one approach, the testing system 100 leverages the model(s) 170 to process the test request 150 and/or the historical data 160, for example, to allocate a remote device to operate as the test device and/or to identify patterns in demand and usage to improve dynamic allocation of the remote devices. The model(s) 170 may comprise various machine learning architectures, including transformer-based models (e.g., large language models (LLMs)) for processing textual data. An LLM, in one approach, is trained on datasets comprising, for example, testing characteristics, historical usage, etc., thereby enabling the system to create and improve allocations. Of course, while LLMs are described, the model(s) 170, in further arrangements, can include deep neural networks (DNNs), recurrent neural networks (RNNs), Support Vector Machines (SVMs), clustering algorithms, Hidden Markov Models, another form of machine learning, or other suitable architectures. It should be appreciated that the separate forms of machine learning algorithms may have distinct applications, such as agent modeling, machine perception, and so on.

The model(s) 170 are, in one embodiment, stored, at least partially, in the data store 140 and may be further integrated with the allocation module 130. Additionally, the model(s) 170 can be trained on the test request 150 and/or the historical data 160. The model(s) 170 are, in one approach, periodically updated using new training data collected during operation and use of the testing system 100 to improve accuracy.

Moreover, it should be appreciated that machine learning algorithms are generally trained to perform a defined task. Thus, the training of the machine learning algorithm is understood to be distinct from the general use of the machine learning algorithm unless otherwise stated. That is, the testing system 100 generally trains the machine learning algorithm according to a particular training approach, which may include supervised training, self-supervised training, reinforcement learning, and so on. In contrast to training/learning of the machine learning algorithm, the testing system 100 implements the machine learning algorithm to perform inference. Thus, the general use of the machine learning algorithm is described as inference.

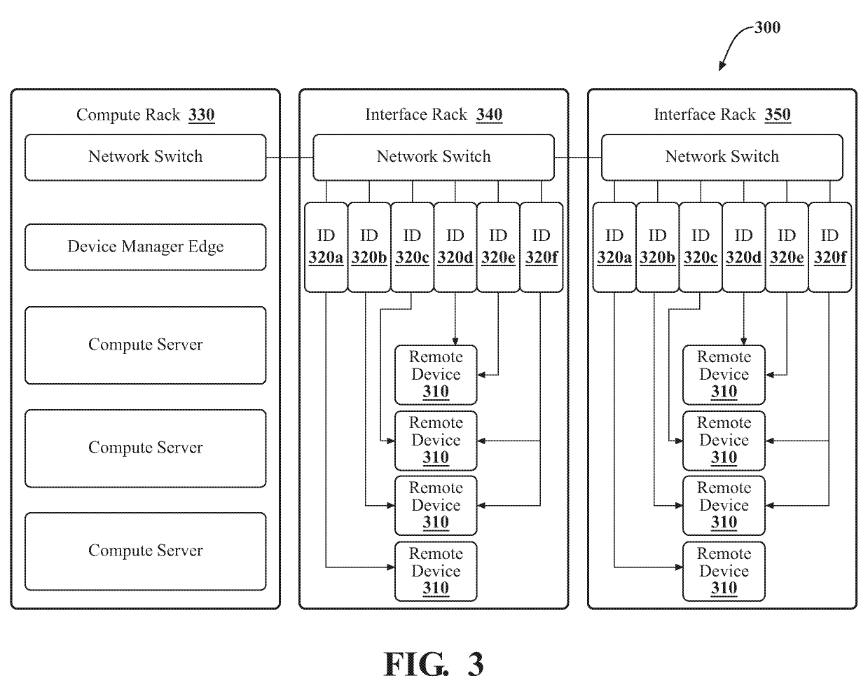

Turning now to FIG. 3, one example of a testing pool 300 is illustrated. As mentioned above, the testing pool 300 includes remote devices 310 that the testing system 100 can allocate to operate as the testing device. As shown in FIG. 3, the testing pool 300 includes four remote devices 310; however, it should be understood that FIG. 3 is just one schematic of the testing pool 300 and that the testing pool 300 can include another number of remote devices 310 and/or separate iterations of rack systems with arrangements of remote devices 310. In fact, the testing pool 300 may include dozens, hundreds, or even thousands of remote devices 310. In one example, the remote devices 310 are vehicle electronic control units (ECUs) that are provided to execute vehicle tests. Accordingly, as most vehicles contain thousands of separate, subsystem-specific ECUs, the testing pool 300 can likewise include thousands of remote devices 310 that may be arranged together to mimic the operation of a test vehicle.

In one embodiment, when the ECUs are installed in a vehicle, the ECUs would ordinarily be connected via a complex wiring harness. Rather than fabricating a unique harness for every configuration, in one approach, the testing system 100 includes interface devices 320 (IDs, which may be vehicle hardware interfaces (VHIs)) to connect the ECUs with an external network by exposing connector pins specific to that ECU as, for example, networked ports. The interface devices 320, in one embodiment, each include a controller, a memory that stores configuration information (e.g., remote device identifiers and a mapping of remote device pins to bridge ports), a transceiver for network communications, and the bridge that exposes the pins for mediated access. By retrieving the stored configuration and generating a mapping of pins to bridge ports, the interface devices 320 allow test services to power, control, and exchange signals with the remote devices 310.

In one arrangement, multiple interface devices 320 (e.g., interface devices 320A-f) can be networked and managed by an edge service. The edge service, in one approach, aggregates configuration information from all connected interface devices 320, effectively learning what remote devices 310 are present and how the pins are exposed through the respective bridges. Using this aggregated information, the edge service can emulate a physical wiring harness by routing signals between remote devices 310 according to a harness mapping, thereby forming a virtual wire harness among multiple remote devices 310 and even across multiple interface devices 320. This arrangement enables flexible, reusable test bench configurations, supports automated or manual testing, and allows complex multi-ECU topologies to be provisioned and reconfigured through software. While FIG. 3 shows an example of remote devices 310 that are ECUs provided with interface devices 320, it should be understood that the remote devices 310 can be other devices as well, for example, other devices-under-test. For example, other remote devices 310 can include sensors, actuators, control or compute modules, communication gateways, or simulated/emulated units.

Moreover, as shown in FIG. 3, one example of a rack system is illustrated as it may be installed within a server. In particular, the rack system is comprised of three primary elements, including a compute rack 330, an interface rack 340, and an interface rack 350. The compute rack 330 includes a network switch to connect with a network to which the other racks 340, 350 are also connected. The compute rack 330 further includes multiple compute servers and a device manager edge. The compute servers may execute various instances of the testing system 100 and/or different test services. Thus, the automated test programs and other software that may interact with the interfaces can be executed on the compute rack 330. The interface racks 340, 350 have similar configurations that include network switches to connect with the network and communicate with the compute rack 330. To the network switches, the interface racks 340, 350 connect multiple interface devices 320 to associated remote devices 310. As such, the rack system provides for implementing complex virtual wire harness via edge and cloud services executing on the compute rack 330. In this way, the adaptable interface devices 320 improve the testing process by avoiding complexities associated with physical harnesses.

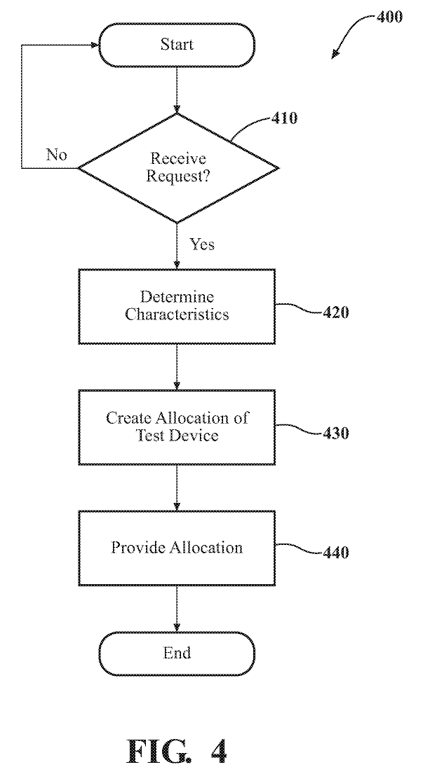

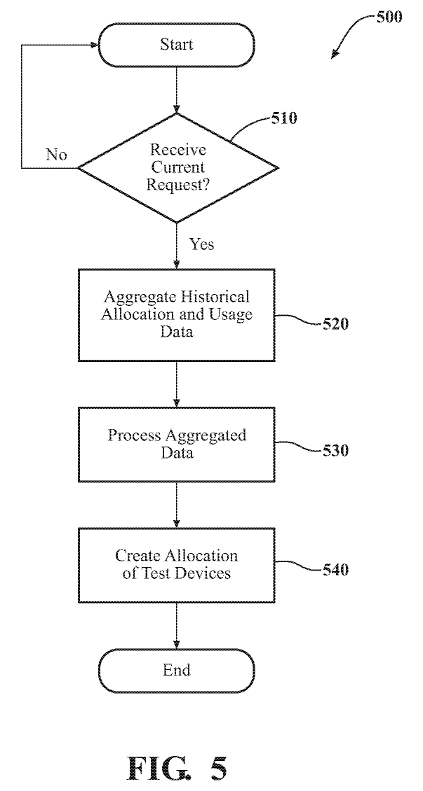

Additional aspects of the testing system 100 will be discussed in relation to FIGS. 4 and 5. FIGS. 4 and 5 illustrate flowcharts of methods 400 and 500 that are associated with allocating testing equipment and optimizing dynamic allocations of testing equipment. The methods 400 and 500 will be discussed from the perspective of the testing system 100 of FIGS. 1 and 2. While the methods 400 and 500 are discussed in connection with the testing system 100, it should be appreciated that the methods 400 and 500 are not limited to being implemented within the testing system 100 but that the testing system 100 is instead one example of a system that may implement the methods 400 and 500. Each method will be described in turn in further detail below.

Turning now to FIG. 4, FIG. 4 illustrates a flowchart of a method 400 that is associated with allocating testing equipment. At 410, the allocation module 130 monitors for a request. The request is, in one embodiment, a request to perform a test using a remote device 310 from the testing pool 300. If the allocation module 130 receives a request, the allocation module 130, in one embodiment, stores the request in the data store 140. If, however, the allocation module 130 does not receive a request, the allocation module 130 continues monitoring for a request, in one embodiment.

Upon receiving the request, in one approach, the allocation module 130 determines various characteristics of the request at 420. In one embodiment, these characteristics include request-side characteristics such as the identity of the requesting user, project code, criticality, requested start time and acceptable completion window, expected duration, and the type of planned or on-demand usage (e.g., smoke, integration, CI/CD, feature testing, debugging). In addition, in one implementation, the request-side characteristics include budget and cost parameters (e.g., engineering-hour costs and delay costs), authorization to access specific devices, and management preferences tied to the project. In one approach, at 420, the allocation module 130 further determines server-side characteristics, including current availability and suitability of remote devices 310 in the testing pool 300, device states (online/offline), compatibility with the requested configuration, and costs. As a result, the allocation module 130 can determine whether there exists a remote device 310 that is suitable to operate as the test device for executing the request, and, if so, choose the best remote device 310 for executing the request.

Upon determining the characteristics, at 430, the allocation module 130, in one embodiment, creates an allocation of a test device. More specifically, at 430, in one approach, the allocation module 130 creates an allocation by allocating one or more remote devices 310 to operate as a test device. In one implementation, the allocation module 130 creates the allocation based, at least in part, on the testing characteristics, including the request-side characteristics and the server-side characteristics.

Moreover, in one embodiment, the allocation module 130 leverages one of the model(s) 170 to create the allocation. For example, the allocation module 130 can utilize a cost optimization model that considers the request-side characteristics and the server-side characteristics to optimize device availability, scheduling constraints, and budget parameters. In one approach, the cost optimization model evaluates available remote devices 310 to minimize an objective function that accounts for engineering-hour costs, device usage rates, and projected utilization, subject to authorization, compatibility, and criticality.

In one example, the allocation module 130 outputs multiple optimized candidate allocations characterized by attributes such as availability window, setup/reconfiguration effort, predicted waiting time, and cost. The allocation module 130 can automatically select the optimal allocation (e.g., minimizing total cost subject to timing constraints and criticality) for reservation and scheduling. In another approach, the allocation module 130 can provide the list of candidate allocations to a user for manual selection by the user. In an illustrative example, the candidate allocations for a medium-criticality request for a 4-hour session within the next 48 hours can include: (1) Allocation A: evening window today with minor setup, short waiting time, lower cost, (2) Allocation B: morning window tomorrow with no setup, longer waiting time, higher cost, and (3) Allocation C: late evening today with moderate reconfiguration, moderate waiting time, moderate cost. Using an automatic selection, the allocation module 130 would select Allocation A to abide by the cost optimization, while a user might manually select Allocation B if the user prefers to execute the test in the daytime during standard working hours.

In any case, based on the optimized outcome, in one approach, the allocation module 130 provides the allocation at 440. More specifically, in one approach, the allocation module 130 provides the allocation to reserve the remote device 310 and schedule a test session for the user. For example, the allocation module 130 automatically reserves the selected remote device 310 and/or automatically schedules a test session within the acceptable timing window for executing the request. To do so, in one approach, the allocation module 130 updates calendar entries or queue positions to reflect the reservation. The allocation module 130 can also issue notifications or credentials required to initiate the session. In another example, the allocation module 130 outputs information to the user about the reserved remote device 310 and/or the test session, for example, when the test session should be reserved, when the request should be executed, etc. The information can also include an identifier for the remote device 310, configuration of the test, start time, expected duration, etc.

In one implementation, providing the allocation includes modifying access to the remote device 310 itself. For example, the allocation module 130 can provide the allocation by allowing the requesting user to access the remote device 310 as the test device to execute the request, while blocking other users from accessing the remote device 310 for the duration of the test. As a result, the allocation module 130 enforces exclusive access to the remote device 310 during the session and releases the remote device 310 upon completion of the request or a timeout.

As mentioned above, in one approach, the allocation module 130 considers a criticality of the request in the optimization and dynamically allocates the remote device 310 according to the specified criticality. For example, for high-criticality or urgent requests, the allocation module 130 prioritizes queue placement, preempts lower-criticality requests, and selects devices with the shortest setup time to minimize waiting times. For medium-criticality requests, the allocation module 130 can prioritize near-term availability while balancing utilization and cost. For low-criticality requests, the allocation module 130 can favor off-peak windows, cost-efficient devices, and consolidated scheduling.

The criticality can be expressed in several forms, either provided for in the request or determined by the allocation module 130. Examples of measures of criticality include a binary non-urgent versus urgent flag; a multi-level classification (e.g., low, medium, high, emergency, etc.); or a numerical scale (e.g., 1–10 where 10 represents the most critical). In one implementation, when a numeric scale is used, the allocation module 130 can escalate scheduling urgency as the score increases or as deadlines approach. In another example, the allocation module 130 can derive the criticality from deadlines (e.g., hard deadline within 24 hours versus flexible completion within a week), program phase (e.g., validation versus exploratory testing), or business impact (e.g., safety-related vs. routine testing).

Moreover, for low-criticality requests, the allocation module 130, in one implementation, allocates a suitable remote device 310 from the testing pool 300 to operate as the test device. In some instances, the remote device 310 is suitable for executing the test but may not meet all of the preferences of the user specified in the request. For example, the allocation module 130 may allocate an earlier-generation ECU that is functionally compatible but lacks optional performance requested by the user, schedule the session in an off-peak overnight window rather than the preferred daytime slot, or allocate a shared test bench configuration instead of a dedicated single-device configuration. In another example, the allocation module 130 may route the test to a geographically distant edge service with available capacity, resulting in a slightly higher network latency that remains within acceptable limits. The allocation module 130 can also consolidate multiple low-criticality requests on the same test bench to reduce setup time. In any case, the allocation module 130 seeks to minimize waiting time and overall cost while reserving optimal devices and timing windows for high-criticality requests.

Turning now to FIG. 5, FIG. 5 illustrates a flowchart of a method 500 that is associated with creating allocations of test devices according to historical data. In some implementations, it may be advantageous to examine historical allocations and usage of test devices to identify patterns in demand for test devices and optimize future allocations based on past demand. Accordingly, FIG. 5 illustrates one example of a method 500 for aggregating historical data and creating allocations of test devices based on the historical data.

In one embodiment, at 510, the allocation module 130 monitors for a request. The request is, in one embodiment, a current request received at a current time to perform a test using a remote device 310 from the testing pool 300. If the allocation module 130 receives a request, the allocation module 130, in one embodiment, stores the request in the data store 140. If, however, the allocation module 130 does not receive a request, the allocation module 130 continues monitoring for a request, in one embodiment.

If the allocation module 130 receives a request, the allocation module 130, in one implementation, aggregates historical allocation and usage data at 520. In one example, the historical data includes data regarding historical allocations of remote devices 310 from the testing pool 300 to operate as test devices. Accordingly, the historical data includes information such as prior requests, request-side characteristics and/or server-side characteristics, which remote devices 310 were allocated based on the characteristics, identifying information regarding the remote devices 310, etc. As mentioned above, the historical data also includes historical usage data, in one embodiment. The historical usage data can include information such as which remote devices 310 were allocated, which remote devices 310 were actually used as test devices, how the remote devices 310 were utilized for a specific request, etc. In one approach, the allocation module 130 aggregates the historical data in the data store 140.

In any case, the allocation module 130, in one arrangement, processes the aggregated data at 530. In one embodiment, the allocation module 130 processes the aggregated data by comparing the historical allocations to the historical usage to identify variances such as over-allocation (reserved remote devices 310 or test bench configurations that were unused or underutilized), under-allocation (test sessions that were delayed or required ad hoc devices due to insufficient capacity), and mismatch conditions (allocated device types or configurations that differed from what was actually utilized during the test session).

Based on the identified variances, the allocation module 130 can, in one embodiment, create an allocation of test devices at 540. In one example, the allocation module 130 uses one of the model(s) 170, which can include knowledge of historical allocations and historical use of the testing pool 300, to adjust device selection and scheduling. The allocation module 130 can do so by setting appropriate reservation lengths, moving low-criticality requests to available time windows, and use devices and setups that match what the test requires so the assigned equipment is compatible with the requested test bench configuration. The model(s) 170 can also recommend adding remote devices 310 to meet demand or removing underused remote devices 310 from test benches. The allocation module 130 can then update reservations of remote devices 310 and log future allocations and uses of remote devices 310 for updates to the model(s) 170.

Moreover, in one embodiment, the allocation module 130 creates the allocation by dynamically optimizing the available remote devices 310 in the testing pool 300 by initiating at least one additional test device to meet demand. For example, the allocation module 130 can initiate a remote device 310 that is not in use to bring the device online to meet demands and minimize waiting times to access test devices.

In another example, the allocation module 130 creates the allocation by reconfiguring an existing test bench to better match current demand. The allocation module 130 can add devices that are identified as needed for upcoming or queued requests or remove devices that are not being used on that bench so they can be repurposed to another bench with higher demand. The allocation module 130 can update reservations and access to reflect the new test bench composition and record the change so the model(s) 170 can further improve future allocations. As a result, optimizes utilization of test devices, shortens wait times, and aligns test bench configurations with actual testing needs.

The arrangements disclosed herein provide the benefit of dynamically allocating testing equipment based on various factors such as demand, testing characteristics, and historical usage to improve utilization and reducing wasted costs and time. The arrangements described herein also provide the benefit of anticipating demand for testing equipment, minimizes waiting times to access testing equipment, and selecting suitable remote devices to meet project criticality and scheduling constraints. This approach enables proactive provisioning of testing equipment, aligns reservations with budget and management preferences, and enforces exclusive access during execution, resulting in more predictable scheduling, lower delays, and optimized cost-to-value for test bench inventory.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some examples, “substantially” can include being within normal manufacturing tolerances.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of … and ….” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A testing system, comprising:
a processor; and
a memory communicably coupled to the processor and storing:
an allocation module including instructions that, when executed by the processor, cause the processor to:
receive a request to perform a test using at least one test device;
determine testing characteristics associated with the request;
create, using an allocation model based, at least in part, on the testing characteristics, an allocation of a remote device from a testing pool to operate as the at least one test device for executing the test; and
provide the allocation to reserve the remote device and schedule a test session.

2. The testing system of claim 1, wherein the instructions to determine the testing characteristics include instructions to determine a criticality of the request, and wherein the instructions to provide the allocation include instructions to dynamically allocate the remote device to operate as the at least one test device according to the criticality.

3. The testing system of claim 2, wherein the instructions to create the allocation include instructions to select the remote device to operate as the at least one test device from the testing pool, wherein the instructions to determine the testing characteristics include instructions to determine a criticality of the request, and wherein the instructions to provide the allocation include instructions to provide an allocation of at least one test device from the testing pool for requests with low criticality to minimize a waiting time for performing the test.

4. The testing system of claim 1, wherein the instructions to receive the request include instructions to acquire the request at a current time, and wherein the instructions further cause the processor to:
aggregate data regarding historical allocations and historical usage of the testing pool; and
identify variances in the historical usage compared to the historical allocations, wherein the instructions to create the allocation include instructions to dynamically optimize available devices in the testing pool by initiating at least one additional test device within the testing pool to meet a testing demand.

5. The testing system of claim 1, wherein the instructions to determine the testing characteristics include instructions to determine a characteristic of the request including a type of test device to satisfy the request for the at least one test device, a criticality, and a time frame for executing the test, and an availability of a device matching device to function as the remote device from the testing pool, and
wherein the instructions to create the allocation include instructions to use a machine learning model that performs an optimization based on the testing characteristics.

6. The testing system of claim 1, wherein the instructions to create the allocation include instructions to use a machine learning model with knowledge of historical allocations and historical use of the testing pool to optimize availability of the at least one test device and minimize waiting times to access the at least one test device.

7. The testing system of claim 1, wherein the instructions to provide the allocation include instructions to allow access by a user associated with the request to the at least one test device for executing the test and block other users from accessing the at least one test device for a duration of the test.

8. A non-transitory computer-readable medium including instructions that, when executed by a processor, cause the processor to:
receive a request to perform a test using at least one test device;
determine testing characteristics associated with the request;
create, using an allocation model based, at least in part, on the testing characteristics, an allocation of a remote device from a testing pool to operate as the at least one test device for executing the test; and
provide the allocation to reserve the remote device and schedule a test session.

9. The non-transitory computer-readable medium of claim 8, wherein the instructions to determine the testing characteristics include instructions to determine a criticality of the request, and wherein the instructions to provide the allocation include instructions to dynamically allocate the remote device to operate as the at least one test device according to the criticality.

10. The non-transitory computer-readable medium of claim 9, wherein the instructions to create the allocation include instructions to select the remote device to operate as the at least one test device from the testing pool, wherein the instructions to determine the testing characteristics include instructions to determine a criticality of the request, and wherein the instructions to provide the allocation include instructions to provide an allocation of at least one test device from the testing pool for requests with low criticality to minimize a waiting time for performing the test.

11. The non-transitory computer-readable medium of claim 8, wherein the instructions to receive the request include instructions to acquire the request at a current time, and wherein the instructions further cause the processor to:
aggregate data regarding historical allocations and historical usage of the testing pool; and
identify variances in the historical usage compared to the historical allocations, wherein the instructions to create the allocation include instructions to dynamically optimize available devices in the testing pool by initiating at least one additional test device within the testing pool to meet a testing demand.

12. The non-transitory computer-readable medium of claim 8, wherein the instructions to determine the testing characteristics include instructions to determine a characteristic of the request including a type of test device to satisfy the request for the at least one test device, a criticality, and a time frame for executing the test, and an availability of a matching device to function as the remote device from the testing pool, and
wherein the instructions to create the allocation include instructions to use a machine learning model that performs an optimization based on the testing characteristics.

13. The non-transitory computer-readable medium of claim 8, wherein the instructions to create the allocation include instructions to use a machine learning model with knowledge of historical allocations and historical use of the testing pool to optimize availability of the at least one test device and minimize waiting times to access the at least one test device.

14. A method, comprising:
receiving a request to perform a test using at least one test device;
determining testing characteristics associated with the request;
creating, using an allocation model based, at least in part, on the testing characteristics, an allocation of a remote device from a testing pool to operate as the at least one test device for executing the test; and
providing the allocation to reserve the remote device and schedule a test session.

15. The method of claim 14, wherein determining the testing characteristics includes determining a criticality of the request, and wherein providing the allocation includes dynamically allocating the remote device to operate as the at least one test device according to the criticality.

16. The method of claim 15, wherein creating the allocation involves selecting the remote device to operate as the at least one test device from the testing pool, wherein determining the testing characteristics includes determining a criticality of the request, and wherein providing the allocation includes providing an allocation of at least one test device from the testing pool for requests with low criticality to minimize a waiting time for performing the test.

17. The method of claim 14, wherein receiving the request includes acquiring the request at a current time, and further comprising:
aggregating data regarding historical allocations and historical usage of the testing pool; and
identifying variances in the historical usage compared to the historical allocations, wherein creating the allocation includes dynamically optimizing available devices in the testing pool including initiating at least one additional test device within the testing pool to meet a testing demand.

18. The method of claim 14, wherein determining the testing characteristics includes determining a characteristic of the request including a type of test device to satisfy the request for the at least one test device, a criticality, and a time frame for executing the test, and an availability of a device matching device to function as the remote device from the testing pool, and
wherein creating the allocation includes using a machine learning model that performs an optimization based on the testing characteristics.

19. The method of claim 14, wherein creating the allocation includes using a machine learning model with knowledge of historical allocations and historical use of the testing pool to optimize availability of the at least one test device and minimize waiting times to access the at least one test device.

20. The method of claim 14, wherein providing the allocation includes allowing access by a user associated with the request to the at least one test device for executing the test and blocking other users from accessing the at least one test device for a duration of the test.
